(19) United States
(12) Patent Application Publication
(10) Pub. No.: US 2024/0083771 A1
(43) Pub. Date: Mar. 14, 2024

(54) Faucet with Integrated Enhanced Water Stream

(71) Applicant: AS America, Inc., Piscataway, NJ (US)

(72) Inventors: Torsten Meier, Neuss (DE); Xiaojing Ye, Edison, NJ (US); Walter Pitsch, Washington, NJ (US)

(73) Assignee: AS America, Inc., Piscataway, NJ (US)

(21) Appl. No.: 18/272,672

(22) PCT Filed: Feb. 10, 2022
(86) PCT No.: PCT/US22/15898

§ 371 Date: Jul. 17, 2023

Related U.S. Application Data
(60) Provisional application No. 63/148,739, filed on Feb. 12, 2021.

(51) Int. Cl. C02F 1/00; E03C 1/04; C02F 1/461; C02F 1/78

(52) U.S. Cl. CPC C02F 1/003; E03C 1/0404; C02F 1/461; C02F 1/78; C02F 2201/005; C02F 2307/06; E03C 2201/40

(57) ABSTRACT

An integrated enhanced water faucet system comprising a faucet assembly and a water treatment assembly; wherein the faucet assembly comprises a multi-channel hose fluidly coupled to a spray head, and a valve cartridge configured to control flow of untreated water; and the water treatment assembly comprises an enhanced water generator and a treatment valve associated with a treatment valve actuator; and wherein the valve actuator is configured to open and close the treatment valve, the system is configured to deliver enhanced water upon actuation of the treatment valve, and untreated water and enhanced water are configured to be delivered to the spray head via separate channels of the multi-channel hose.

The disclosure is directed to a faucet system configured to deliver enhanced and non-enhanced water. In some embodiments, an enhanced water stream may provide deep cleaning and sanitization.

### BACKGROUND

A simple, easy-to-use kitchen device to wash food items, hands, and/or kitchen items or other items is highly desired. Faucets are omnipresent plumbing fixtures having the capability to deliver hot water, cold water or a hot water/cold water mixture from a water source (e.g. tap or well water). There is a need for a more durable, simpler, and easy-to-use an integrated enhanced water delivery system, for example an enhanced water stream for deep cleaning and sanitization.

### SUMMARY

Accordingly, disclosed is an integrated enhanced water faucet system comprising a faucet assembly and a water treatment assembly; wherein the faucet assembly comprises a multi-channel hose fluidly coupled to a spray head, and a valve cartridge configured to control flow of untreated water; and the water treatment assembly comprises an enhanced water generator and a treatment valve associated with a treatment valve actuator; and wherein the valve actuator is configured to open and close the treatment valve, the system is configured to deliver enhanced water upon actuation of the treatment valve, and untreated water and enhanced water are configured to be delivered to the spray head via separate channels of the multi-channel hose.

Also disclosed is a water treatment assembly comprising an enhanced water generator; and a treatment valve associated with a valve actuator; wherein, the valve actuator is configured to open and close the treatment valve; and the system is configured to deliver enhanced water upon actuation of the treatment valve.

### BRIEF DESCRIPTION OF THE DRAWINGS

The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1A depicts an integrated faucet, enhanced water treatment system, according to an embodiment.

FIG. 1B and FIG. 1C depict upper and lower portions of a multi-channel hose as disposed in a faucet spout, according to some embodiments.

FIG. 1D depicts a cross-section of a multi-channel hose according to an embodiment.

FIG. 1E displays a spray head with a cross-section of a spout according to an embodiment.

### DETAILED DISCLOSURE

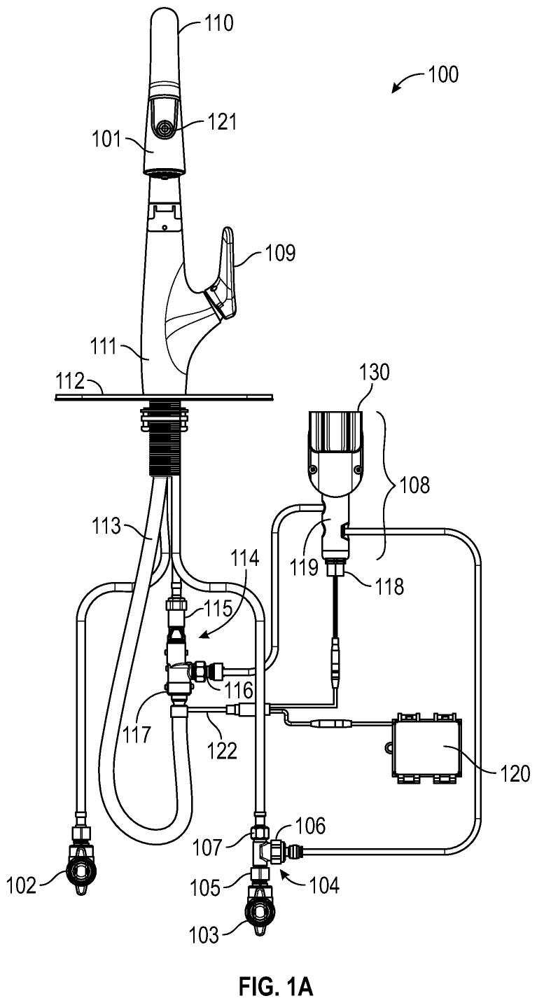

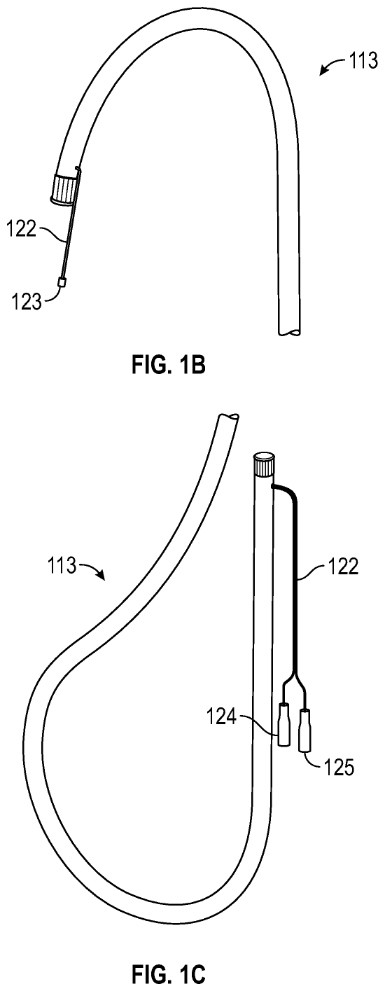

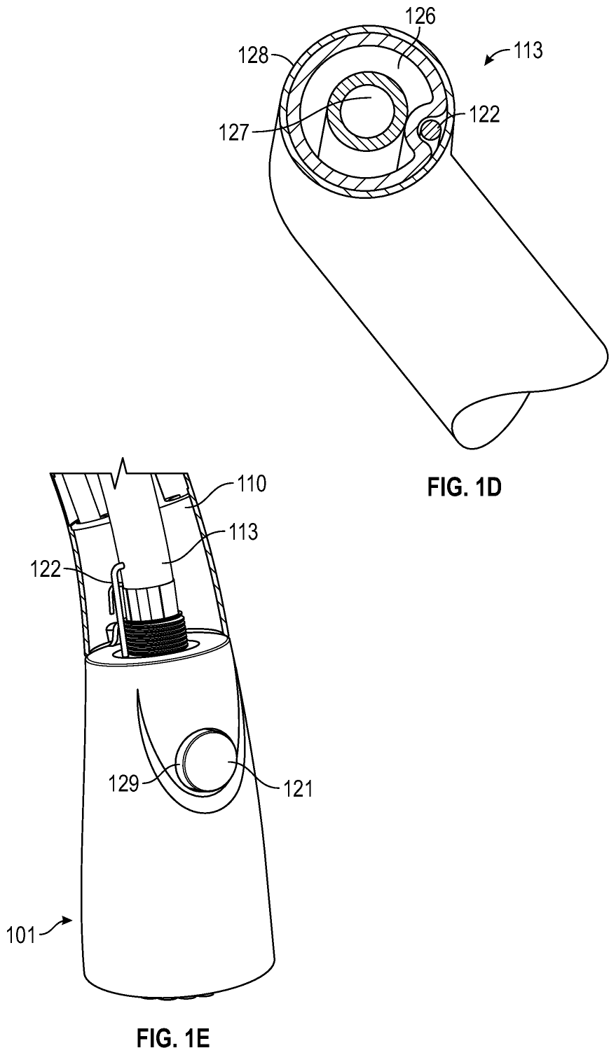

FIG. 1A depicts integrated faucet system 100, according to an embodiment. Integrated system 100 comprises a pull-down faucet with spray head 101 shown in a docked position. Hot and cold water is delivered to the system from a water source to inlets 102 and 103, respectively. First T-connector 104 contains first branch 105 configured to receive cold source water from cold water inlet 103. First T-connector 104 second branch 106 is configured to deliver untreated (non-enhanced) water to treatment assembly 108. Assembly 108 contains manifold 119, generator 130, and solenoid 118. First T-connector 104 contains third branch 107 configured to deliver untreated water to a valve cartridge associated with faucet handle 109. The faucet also comprises spout 110, faucet body 111, spray head 101 and base 112. Multi-channel hose 113 is in fluid communication with spray head 101, disposed in body 111, and connected to second T-connector 114. Second T-connector 114 contains first branch 115 configured to receive untreated water from the valve cartridge, second branch 116 configured to receive enhanced water from treatment assembly 108, and third branch 117 configured to deliver enhanced and untreated water to different channels of multi-channel hose 113. Enhanced water flow is configured to be started/stopped by opening/closing solenoid valve 118 disposed in treatment assembly 108. Solenoid valve 118 is electrically connected to power source 120, which comprises one or more batteries. Spray head 101 comprises button 121 configured to electronically actuate solenoid valve 118 and to start/stop enhanced water flow. Electric cable 122 is disposed in multi-channel hose 113, exits below T-connector 114, and also exits the multi-channel hose inside the spray head to connect to button 121. Electric cable 122 connects to button 121 via a connection (not visible). Electric cable 122 connects to solenoid 118 and to power source 120 with connections (respectively, not visible).

In an embodiment, treatment assembly 108 comprises an ozone generator. In another embodiment, treatment assembly 108 comprises an electrolytic cell. In another embodiment, treatment assembly 108 comprises a reservoir to deliver an antimicrobial additive or additive concentrate. Accordingly, in some embodiments, generator 130 may comprise a reservoir, an ozone generator, or an electrolytic cell. In some embodiments, enhanced water may comprise ozone-infused water, NaOCl-infused water, electrolyzed water, or antimicrobial-infused water.

FIG. 1B and FIG. 1C depict an upper portion of multi-channel hose 113 as disposed in a faucet spout and below a deck with slack to allow for pull-down of a spray head, respectively, according to an embodiment. FIG. 1B shows a portion of electric cable (wire) 122 exiting multi-channel hose 113 and having connection point 123 configured to attach to electronic actuator 121 disposed on spray head 101. FIG. 1C shows a portion of electric cable 122 exiting multi-channel hose 113 and configured to connect with solenoid valve 118 via connection point 124 and to connect with power source 120 via connection point 125.

FIG. 1D shows a cross-section view of multi-channel hose 113 according to an embodiment, having electric cable 122 disposed within it. Shown is a channel 126 for delivery of untreated water to spray head 101 and inner channel 127 for delivery of enhanced water to spray head 101. Also shown is cover layer 128, which layer may comprise braided nylon or stainless steel.

FIG. 1E shows spray head 101 according to an embodiment, coupled to faucet spout 110 shown in cross-section. Visible in the spout cross-section are electric cable 122 exiting multi-channel hose 113. Electric cable 122 is electrically coupled to electronic button 121 via connection point 123 (not visible). Electric button 121 is configured to open/close solenoid valve 118 associated with treatment assembly 108. Encircling button 121 is an LED indicator 129, configured to provide a status of enhanced water. In an embodiment, a push of button 121 will open solenoid 118 to provide enhanced water to spray head 101. LED 129 may be configured to light (for example green, red, blue, etc.) to indicated enhanced water has reached spray head 101 and is ready to use. There may be a delay between activation of solenoid 118 and an indication that enhanced water is ready to use. In an embodiment, a second push of button 121 may close solenoid to stop flow of enhanced water. Handle 109 will be in a closed position to activate/deactivate enhanced water delivery.

In some embodiments, an enhanced water stream may contain one or more antimicrobial compounds capable of killing, disabling, and/or inhibiting growth of harmful bacterial and/or viruses. In some embodiments, an enhanced water stream may be employed to wash food items, such as fruits, vegetables, and meats. In some embodiments, an enhanced water stream may be employed to deep clean or sanitize hands, kitchen items, or other items.

In some embodiments, antimicrobial compounds may include one or more of chlorine, ozone, or sodium hypochlorite. In some embodiments, antimicrobial compounds may include essential oils such as oils of bay, cinnamon, clove, or thyme. In some embodiments, antimicrobial compounds may include organic acids such as acetic acid, citric acid, or lactic acid, including organic or metal salts thereof. In some embodiments, antimicrobial compounds may include metals, alloys, or organometallic compounds comprising one or more of copper, silver, or zinc, including ionic forms thereof. In some embodiments, antimicrobial compounds may include organic compounds such as triclosan.

In some embodiments, enhanced water may be prepared by electrolyzing tap water. In some embodiments, enhanced water may be prepared via an ozone generator. In some embodiments, enhanced water may be prepared via addition of certain amounts of an antimicrobial compound, or enhancement additive, from a reservoir containing the additive or an additive concentrate or solution. In some embodiments, a reservoir may be associated with an electric pump, and/or other associated features including a nozzle, tubing, etc. A treatment valve may be configured to operate a reservoir, an ozone generator, an electrolytic cell, etc.

In some embodiments, actuation of a treatment valve is configured to provide an enhanced water stream. In some embodiments, actuation of a treatment valve is configured to generate an antimicrobial additive, for example generate ozone or NaOCl, and to provide a resulting enhanced water stream. In some embodiments, an antimicrobial additive, for example ozone or NaOCl, may be generated “on demand”, via electrolysis, UV light, or other method.

In some embodiments, actuation of a mechanical treatment valve may result in closing an electric circuit to actuate an enhancement generator to initiate preparation of an enhancement additive. In some embodiments, actuation of a mechanical treatment valve may result in closing an electric circuit to actuate a nozzle or other device to initiate delivery of an enhancement additive to a water stream.

In some embodiments, actuation of a solenoid treatment valve may also actuate an enhancement generator to initiate preparation of an enhancement additive. In some embodiments, actuation of a solenoid treatment valve may also actuate a nozzle or other device to initiate delivery of an enhancement additive to a water stream.

In an embodiment, an integrated generation/infusion system comprises a faucet assembly, a water treatment assembly and first and second T-connectors. A faucet assembly may comprise a faucet body, a spout, a valve cartridge and a spray head. In some embodiments, the spray head may be a pull-out or pull-down spray head in fluid communication with a multi-channel hose running through the spout and body.

A multi-channel hose is described for example in U.S. Pat. No. 10,183,871, the contents of which are hereby incorporated by reference. In one embodiment, a multi-channel hose may have enough slack to allow for the spray head to be pulled out or down (pulled away from) and returned to the spout. In an embodiment, the multi-channel hose comprises a channel dedicated to delivering untreated water and a channel dedicated to delivering enhanced water. In general, “untreated water” means source water that is not enhanced. A multi-channel hose may comprise a flexible material to allow for ease of pull-away from and return to the spout.

In some embodiments, a multi-channel hose comprises two or more concentric layers, wherein an interior layer provides a waterway for enhanced water and a space between the interior layer and an outer layer provides a waterway for untreated water, or visa-versa. The spray head may comprise corresponding waterways for receiving the enhanced and untreated water from the hose. In an embodiment, spray head waterways run from a reception portion of the spray head which is coupled to the multi-channel hose, through the spray head, and to corresponding outlets of the spray head configured for separate dispensing of enhanced and untreated water.

A third branch of the second T-connector may be configured to supply untreated water to an untreated water waterway of the multi-channel hose and to supply enhanced water to an enhanced water waterway of the multi-channel hose. A third branch of the second T-connector may comprise concentric water paths configured to couple to concentric waterways of a multi-channel hose. In some embodiments, first and second T-connectors do not require any diverter mechanism, for example any water-controlled diverter mechanism.

In an embodiment, a multi-channel hose may comprise a bonnet configured to couple to a spray head reception portion. A bonnet may include one or more sealing components configured to seal the connection between the multi-channel hose and the spray head.

In some embodiments, a system comprises an activation device in electronic communication with a solenoid valve associated with a water treatment assembly. In certain embodiments, an electronic activation device, or “electronic actuator” is present on the spray head. Electrical communication may be via a wire (electric cable) connected to the electronic actuator and the solenoid valve. In some embodiments, a wire may be disposed in the multi-channel hose. A wire may exit the hose at a certain location to connect to the solenoid valve. A wire may also be connected to a power source such as a battery. In other embodiments, electrical communication may be wireless, for example Wi-Fi, near field communication, Bluetooth® or ZigBee communication protocols.

The electronic actuator may be present on a front, back, or a side of the spray head. In some embodiments, an electronic actuator may be a toggle switch, a button, a lever, a knob, etc. In some embodiments, an electronic actuator may be configured so that when placed in an “on” position, the solenoid valve is opened, water flows through a water treatment assembly and the faucet delivers enhanced water. When the electronic actuator is placed in an “off” position, the solenoid valve is closed and water ceases to flow through the water treatment assembly and enhanced water ceases to flow. In some embodiments, an electronic actuator may be configured so that when manipulated a first time, the solenoid valve is opened to provide enhanced water flow and when manipulated a second time, the solenoid valve is closed to stop enhanced water flow. In other embodiments, the electronic actuator may have to be held to deliver enhanced water and released to stop enhanced water flow.

In some embodiments, the electronic actuator may be a button that when pushed a first time, enhanced water is delivered by the faucet, and when pushed a second time, enhanced water flow ceases and enhanced water delivery stops. The electronic actuator may be associated with a circuit board.

In some embodiments, built-in electronics of an integrated system may be configured to allow only a specified amount of antimicrobial additive or enhanced water to be delivered within a certain time period; or in another embodiment, may be configured to allow for enhanced water flow for a certain amount of time over a specified time period.

In other embodiments, an electronic actuator may be present on the spout, faucet body, or on a faucet base. In some other embodiments, an electronic actuator may be positioned proximate to a water treatment assembly. In this instance a wire connecting the electronic actuator to the solenoid valve may be positioned outside of the multi-channel hose; or alternatively, the electronic actuator may be in wireless electrical communication with the solenoid valve.

In some embodiments, a water treatment assembly is not under pressure when the solenoid is in the default “off” position. Accordingly, the system may not require any pressure regulator that otherwise might be required to ensure a water treatment assembly is not under excess water pressure. The term “under pressure” meaning the pressure of source water.

In some embodiments, an integrated system may comprise one or more indicator lights, configured to display a status of a water treatment assembly, status of enhanced water and/or a battery status. In some embodiments, an electronic actuator may be associated with an indicator light, the light configured to display a status of a generator and/or a battery status. For example, with a button having a circular shape, a status indicator light may be configured as a ring encircling the button or as a light proximate the button. In some embodiments, an indicator light may comprise an LED (light emitting diode). In some embodiments, an electronic actuator may be configured to activate a generator and to pass water through a water treatment assembly to prepare enhanced water. In some embodiments, an indicator light may be configured to light a certain color to indicate enhanced water has reached a desired antimicrobial additive concentration and is ready for use. In some embodiments, there may be a delay between a time a water treatment assembly is activated and a time that enhanced water is ready for use.

An indicator light may be configured to provide light of different colors (e.g. white, blue, green, red, orange, etc.) indicating that a generator and/or battery is good or no-good and requires replacing—or indicating that a generator and/or battery has a certain expected life remaining, for example 180 days, 150 days, 120 days, 90 days, 60 days, 45 days, 30 days, 15 days, 10 days, or 5 days.

In some embodiments, the integrated system may comprise only one activation device, for instance only the electronic actuator. In other embodiments, the integrated system may comprise an electronic actuator and a mechanical actuator. An electronic actuator and a mechanical actuator may be positioned proximate or distal to each other. In some embodiments, an electronic actuator and a mechanical actuator may both be positioned on the spray head. A mechanical actuator may be configured to select and provide for untreated water in different forms, for instance in an aerated form, a spray form, a shower form, a non-aerated single stream form, etc. The spray head may comprise different outlets for each of the different untreated water forms.

In some embodiments, a valve cartridge configured to control flow of untreated water may be associated with a mechanical actuator, for instance a handle.

In some embodiments, a treatment valve is associated with a water treatment assembly and may be configured to allow/disallow water flow through the water treatment assembly to provide enhanced water flow when placed in a corresponding open or closed position.

In some embodiments, a water treatment assembly may comprise a manifold configured to receive untreated water from a second branch of a first T-connector and to deliver enhanced water to a second branch of a second T-connector. In some embodiments, untreated water enters an inlet of a manifold, is treated with antimicrobial additive, and enhanced water exits an outlet of the manifold. In some embodiments, a treatment valve may be disposed in a water treatment assembly manifold and/or coupled to a manifold. In some embodiments, both a generator and a treatment valve may be disposed in a water treatment assembly manifold and/or coupled to a water treatment assembly manifold.

In an embodiment, the faucet assembly may comprise a mixed water hose in fluid communication with a valve cartridge and configured to deliver untreated water from the valve cartridge to a first branch of a second T-connector. The mixed water hose may deliver cold water, hot water, or a hot/cold water mixture, adjustable via a faucet handle associated with the valve cartridge. A faucet handle associated with the valve cartridge may control temperature of untreated water and also volume of untreated water flow.

In some embodiments, a valve cartridge is disposed in the faucet body and is associated with a faucet handle. The valve cartridge is configured to receive untreated hot and cold water from hot and cold water supplies. The valve cartridge is configured to deliver hot, cold or mixed hot/cold water a mixed water hose. In some embodiments, the valve cartridge controls untreated water only.

The faucet assembly in use may be positioned on a deck (i.e. a countertop). In some embodiments, a water treatment assembly may be positioned in use so that it is accessible from above a deck. In this instance, a water treatment assembly or a part thereof may be replaced, that is removed and a new one installed, from above deck. In other embodiments, a water treatment assembly may be positioned below deck. In this instance, a water treatment assembly may be accessed from inside a cabinet under the deck.

In some embodiments, enhanced water is cold water. In some embodiments, a single handle of a faucet assembly must be in a closed position for enhanced water to be delivered.

Following are some son-limiting embodiments of the disclosure.

In a first embodiment, disclosed is an integrated enhanced water faucet system comprising a faucet assembly and a water treatment assembly; wherein the faucet assembly comprises a multi-channel hose fluidly coupled to a spray head, and a valve cartridge configured to control flow of untreated water; and the water treatment assembly comprises an enhanced water generator and a treatment valve associated with a treatment valve actuator; and wherein the valve actuator is configured to open and close the treatment valve, the system is configured to deliver enhanced water upon actuation of the treatment valve, and untreated water and enhanced water are configured to be delivered to the spray head via separate channels of the multi-channel hose.

In a second embodiment, disclosed is an integrated enhanced water faucet system according to the first embodiment, comprising a faucet assembly; a water treatment assembly; a first T-connector; and a second T-connector; wherein, the faucet assembly comprises a body; a spout; a spray head; a multi-channel hose fluidly coupled to the spray head and disposed in the spout; and a valve cartridge configured to control flow of untreated water; the water treatment assembly comprises an enhanced water generator; and a treatment valve associated with a treatment valve actuator; the first T-connecter comprises a first branch configured to receive untreated water from a water source; a second branch configured to deliver untreated water to the water treatment assembly; and a third branch configured to deliver untreated water to the valve cartridge; and the second T-connecter comprises a first branch configured to receive untreated water from the valve cartridge; a second branch configured to receive enhanced water from the water treatment assembly; and a third branch configured to deliver the enhanced and untreated water from the first and second branches to different channels of the multi-channel hose; and wherein, the valve actuator is configured to open and close the treatment valve; and the system is configured to deliver enhanced water upon actuation of the treatment valve.

In a third embodiment, disclosed is a system according to the first or second embodiments, wherein the enhanced water generator comprises an ozone generator, an electrolytic cell, or a reservoir. In a fourth embodiment, disclosed is a system according to any of the preceding embodiments, wherein the enhanced water comprises ozone-infused water, sodium hypochlorite-infused water, electrolyzed water, or antimicrobial additive-infused water.

In a fifth embodiment, disclosed is a system according to any of embodiments 1 to 4, wherein the water treatment assembly comprises a mechanical valve associated with a mechanical actuator. In a sixth embodiment, disclosed is a system according to any of embodiments 1 to 4, wherein the water treatment assembly comprises a solenoid valve in electrical communication with an electronic valve actuator. In a seventh embodiment, disclosed is a system according to any of the preceding embodiments, wherein the system is configured to prepare enhanced water upon actuation of the treatment valve.

In an eighth embodiment, disclosed is a system according to any of the preceding embodiments, wherein the system is configured to prepare an enhancement additive upon actuation of the treatment valve.

In a ninth embodiment, disclosed is a system according to any of the preceding embodiments, comprising a mechanical actuator configured to provide a mixture of hot and cold water to the spray head.

In a tenth embodiment, disclosed is a system according to any of the preceding embodiments, wherein the treatment valve actuator is configured to be manipulated a first time to open the treatment valve to deliver enhanced water, and to be manipulated a second time to close the treatment valve to stop enhanced water flow. In an eleventh embodiment, disclosed is a system according to any of the preceding embodiments, wherein the treatment valve actuator is configured to be manipulated a first time to initiate enhanced water generation, and to be manipulated a second time to cease enhanced water generation.

In a twelfth embodiment, disclosed is a system according to any of the preceding embodiments, wherein the spray head is configured to be pulled away from and returned to (docked to) the spout.

In a thirteenth embodiment, disclosed is a system according to any of the preceding embodiments, wherein an electronic actuator and a solenoid valve are in electrical communication via a wire disposed in the multi-channel hose.

In a fourteenth embodiment, disclosed is a system according to any of the preceding embodiments, wherein the water treatment assembly comprises a manifold configured to receive untreated water from the first T-connector and to deliver enhanced water to the second T-connector.

In a fifteenth embodiment, disclosed is a system according to any of the preceding embodiments, wherein the system comprises one or more indicator lights, the indicator lights configured to indicate when enhanced water is ready to use.

In a sixteenth embodiment, disclosed is a system according to any of the preceding embodiments, comprising a battery, wherein the battery is in electrical communication with a solenoid treatment valve.

In a seventeenth embodiment, disclosed is a system according to any of the preceding embodiments, comprising an electronic treatment valve actuator positioned on the spray head.

In an eighteenth embodiment, disclosed is a system according to any of the preceding embodiments, wherein the valve cartridge is disposed in the faucet body and associated with a faucet handle, and wherein the valve cartridge is configured to deliver hot water, cold water, or a hot water/cold water mixture to the second T-connector.

In a nineteenth embodiment, disclosed is a system according to any of the preceding embodiments, wherein the valve cartridge is configured to deliver only untreated water.

In a twentieth embodiment, disclosed is a system according to any of the preceding embodiments, wherein the water treatment assembly comprises a manifold and the treatment valve is disposed in and/or coupled to the manifold. In a twenty-first embodiment, disclosed is a system according to any of the preceding embodiments, wherein the water treatment assembly comprises a manifold and the generator is disposed in and/or coupled to the manifold. In a twenty-second embodiment, disclosed is a system according to any of the preceding embodiments, wherein when the treatment valve is closed, the water treatment assembly is not under water pressure.

In a twenty-third embodiment, disclosed is a water treatment assembly comprising an enhanced water generator; and a treatment valve associated with a valve actuator; wherein, the valve actuator is configured to open and close the treatment valve; and the system is configured to deliver enhanced water upon actuation of the treatment valve.

In a twenty-fourth embodiment, disclosed is an assembly according to embodiment 23, wherein the enhanced water generator comprises an ozone generator, an electrolytic cell, or a reservoir. In a twenty-fifth embodiment, disclosed is an assembly according to embodiments 23 or 24, wherein the enhanced water comprises ozone-infused water, sodium hypochlorite-infused water, electrolyzed water, or antimicrobial additive-infused water.

In a twenty-sixth embodiment, disclosed is an assembly according to any of embodiments 23 to 25, comprising a mechanical valve associated with a mechanical actuator. In a twenty-seventh embodiment, disclosed is an assembly according to any of embodiments 23 to 26, comprising a solenoid valve in electrical communication with an electronic valve actuator.

In a twenty-eighth embodiment, disclosed is an assembly according to any of embodiments 23 to 27, wherein the enhanced water comprises ozone-infused water, sodium hypochlorite-infused water, electrolyzed water, or antimicrobial additive-infused water.

In a twenty-ninth embodiment, disclosed is an assembly according to any of embodiments 23 to 28, wherein the system is configured to prepare enhanced water upon actuation of the treatment valve. In a thirtieth embodiment, disclosed is a system according to any of embodiments 23 to 29, wherein the assembly is configured to prepare an enhancement additive upon actuation of the treatment valve.

In a thirty-first embodiment, disclosed is an assembly according to any of embodiments 23 to 30, comprising a manifold configured to receive untreated water from a water source and to deliver enhanced water to a plumbing fixture. In a thirty-second embodiment, disclosed is an assembly according to any of embodiments 23 to 31, wherein the treatment valve is disposed in and/or coupled to a manifold. In a thirty-third embodiment, disclosed is an assembly according to any of embodiments 23 or 32, wherein the generator is disposed in and/or coupled to a manifold.

In a thirty-fourth embodiment, disclosed is an assembly according to any of embodiments 23 to 33, wherein when the treatment valve is closed, the water treatment assembly is not under water pressure.

When elements are configured to receive from or configured to deliver or provide to another element, or when elements are coupled to other elements regarding fluid flow, the elements are in fluid communication with each other.

The term “flow communication” or “fluid communication” means for example configured for liquid or gas flow therethrough and may be synonymous with “fluidly coupled”. The terms “upstream” and “downstream” indicate a direction of gas or fluid flow, that is, gas or fluid will flow from upstream to downstream.

Likewise, “electrical communication” may mean “electrically coupled”. Electrical communication may be via wired connection or may be wireless.

The terms “coupled” or “connected” may mean that an element is “attached to” or “associated with” another element. Coupled or connected may mean directly coupled or coupled through one or more other elements. An element may be coupled to an element through two or more other elements in a sequential manner or a non-sequential manner. The term “via” in reference to “via an element” may mean “through” or “by” an element. Coupled or connected or “associated with” may also mean elements not directly or indirectly attached, but that they “go together” in that one may function together with the other.

The term “towards” in reference to a of point of attachment, may mean at exactly that location or point or, alternatively, may mean closer to that point than to another distinct point, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more of the definition; for example the term “substantially perpendicular” may mean the 90° perpendicular angle may mean “about 90°”. The term “generally” may be equivalent to “substantially”.

Features described in connection with one embodiment of the disclosure may be used in conjunction with other embodiments, even if not explicitly stated.

Embodiments of the disclosure include any and all parts and/or portions of the embodiments, claims, description and figures. Embodiments of the disclosure also include any and all combinations and/or sub-combinations of embodiments.

1. An integrated enhanced water faucet system comprising a faucet assembly and a water treatment assembly,
wherein,
the faucet assembly comprises a faucet body, a faucet spout, a multi-channel hose fluidly coupled to a spray head, and a valve cartridge configured to control flow of untreated water, and
the water treatment assembly comprises an enhanced water generator and a treatment valve associated with a treatment valve actuator, and
wherein,
the treatment valve actuator is configured to open and close the treatment valve,
the system is configured to deliver enhanced water upon actuation of the treatment valve,
untreated water and enhanced water are configured to be delivered to the spray head via separate channels of the multi-channel hose, and
the valve cartridge is configured to deliver only untreated water.

2. The integrated enhanced water faucet system according to claim 1 comprising a first T-connector and a second T-connector, wherein,
the first T-connecter comprises a first branch configured to receive untreated water from a water source, a second branch configured to deliver untreated water to the water treatment assembly, and a third branch configured to deliver untreated water to the valve cartridge, and
the second T-connecter comprises a first branch configured to receive untreated water from the valve cartridge, a second branch configured to receive enhanced water from the water treatment assembly, and a third branch configured to deliver the enhanced water and untreated water from the first and second branches to different channels of the multi-channel hose.

3. The system according to claim 1, wherein the enhanced water generator comprises an ozone generator, an electrolytic cell, or a reservoir, and wherein the enhanced water comprises ozone-infused water, sodium hypochlorite-infused water, electrolyzed water, or antimicrobial additive-infused water.

4. The system according to claim 1, wherein the water treatment assembly comprises a solenoid valve in electrical communication with an electronic treatment valve actuator, wherein the electronic valve actuator and the solenoid valve are in electrical communication via a wire disposed in the multi-channel hose, and wherein the electronic valve actuator is positioned on the spray head.

5. The system according to claim 1, wherein the system is configured to prepare the enhanced water upon actuation of the treatment valve and/or, wherein the system is configured to prepare an enhancement additive upon actuation of the treatment valve.

6. The system according to claim 1, wherein the valve cartridge is disposed in the faucet body and associated with a faucet handle, and wherein the valve cartridge is configured to deliver hot water, cold water, or a hot water/cold water mixture to the spray head.

7. The system according to claim 1, wherein the treatment valve actuator is configured to be manipulated a first time to open the treatment valve to deliver enhanced water, and to be manipulated a second time to close the treatment valve to stop enhanced water flow.

8. The system according to claim 1, wherein the treatment valve actuator is configured to be manipulated a first time to initiate enhanced water generation, and to be manipulated a second time to cease enhanced water generation.

9. The system according to claim 1, wherein the water treatment assembly comprises a manifold and the treatment valve is disposed in and/or coupled to the manifold.

10. The system according to claim 1, wherein the water treatment assembly comprises a manifold and the generator is disposed in and/or coupled to the manifold.

11. The system according to claim 1, wherein when the treatment valve is closed, the water treatment assembly is not under water pressure.

12. A water treatment assembly comprising an enhanced water generator and a treatment valve associated with a treatment valve actuator, wherein,
the treatment valve actuator is configured to open and close the treatment valve,
the system is configured to deliver enhanced water upon actuation of the treatment valve, and
when the treatment valve is closed, the water treatment assembly is configured to not be under water pressure.

13. The assembly according to claim 12, wherein the enhanced water generator comprises an ozone generator, an electrolytic cell, or a reservoir, and wherein the enhanced water comprises ozone-infused water, sodium hypochlorite-infused water, electrolyzed water, or antimicrobial additive-infused water.

14. The assembly according to claim 12, comprising a mechanical valve associated with a mechanical actuator.

15. The assembly according to claim 12, comprising a solenoid valve in electrical communication with an electronic valve actuator.

16. The assembly according to claim 12, wherein the enhanced water comprises ozone-infused water, sodium hypochlorite-infused water, electrolyzed water, or antimicrobial additive-infused water.

17. The assembly according to claim 12, wherein the system is configured to prepare enhanced water upon actuation of the treatment valve and/or, wherein the assembly is configured to prepare an enhancement additive upon actuation of the treatment valve.

18. The assembly according to claim 12, comprising a manifold configured to receive untreated water from a water source and to deliver enhanced water to a plumbing fixture.

19. The assembly according to claim 18, wherein the treatment valve is disposed in and/or coupled to the manifold.

20. The assembly according to claim 18, wherein the generator is disposed in and/or coupled to the manifold.
